(19) United States
(12) Patent Application Publication
(10) Pub. No.: US 2011/0192159 A1
(43) Pub. Date: Aug. 11, 2011

(54) WAVE-POWERED ENERGY GENERATION APPARATUS

(75) Inventors: Matthew Morgan, Queensland (AU); Andrew Horton, New South Wales (AU)

(73) Assignee: PROTEUS WAVE POWER PTY LTD., Queensland (AU)

(21) Appl. No.: 13/058,167

(22) PCT Filed: Aug. 10, 2009
(86) PCT No.: PCT/AU2009/001020

§ 371 Date: Apr. 28, 2011

(30) Foreign Application Priority Data
Aug. 8, 2008 (AU) 2008904065

(51) Int. Cl. F03B 13/18; B63B 39/03

(52) U.S. Cl. 60/497; 114/125

(57) ABSTRACT

A wave-powered energy generation apparatus (10) comprises a plurality of pontoons (12) articulatingly connected to each other. A centre pontoon (12.2) is substantially curved. The apparatus (10) has a mooring point (19) for mooring the apparatus (10) in a body of water. The apparatus (10) also has a power generation system which is powered by articulating movement between the pontoons.

### FIELD OF THE INVENTION

This invention relates to a wave-powered energy generation apparatus. In particular, although not exclusively, this invention relates to a surface-following articulated wave-powered energy generation apparatus having at least one curved pontoon.

### BACKGROUND TO THE INVENTION

Worldwide there has been exponential growth in demand for energy. This demand is increasingly being satisfied by renewable energy sources as non-renewable energy sources are environmentally destructive and become expensive and depleted.

Ocean wave energy is one of the renewable energy sources showing an increase in commercial viability. Indeed a number of patent applications have been filed for apparatus which harness ocean wave energy. These include U.S. Pat. Nos. 4,077,213, 4,686,377, 4,048,512, and 6,476,511. U.S. Pat. No. 6,476,511 describes an articulated surface-following structure which permits articulating movement between body members. Power is then extracted from the articulating movement between body members by placing pistons between the body members, which pistons are driven by the articulating movement. One of the drawbacks of this structure is that it needs to be tuned for maximum efficiency with the ocean waves by a complex system of roll bias angle tuning. The hinge structures between adjacent body members of this structure does not allow for relative rolling movement between adjacent body members to extract further power. This is understandable as all the body members are generally cylindrically shaped and thus no or little relative rolling movement is expected between the adjacent body members. Tuning further involves mooring the structure at an angle relative to the mean wave direction with mooring wires which arrest the structure in the preferred orientation. Angling the articulated structure relative to the mean wave direction increases the efficiency of power generation in certain ocean conditions.

One of the drawbacks of articulating surface-following structures, is the length of the individual pontoons are restricted due to their longitudinally straight shape. Unless restricted in length, longitudinally straight shaped pontoons tend to experience dangerously high angles of pitching and large slamming loads when subject to storm conditions at sea.

### OBJECT OF THE INVENTION

It is an object of the invention to overcome, or at least alleviate one or more of the above problems and/or provide the consumer with a useful or commercial choice.

It is a further objection of the invention to provide an efficient wave-powered energy generation apparatus which captures a higher percentage of the available energy in waves over a range of changeable conditions, when compared with prior art wave-powered energy apparatus.

It is a further object of the invention to provide improved means for orientating a wave-powered energy generation apparatus relative to the mean direction of the waves.

It is a further object of the invention to overcome the limitation on pontoon length of wave-powered energy apparatus.

Further objects will be evident from the following description.

### SUMMARY OF THE INVENTION

According to one aspect of the invention there is provide a wave-powered energy generation apparatus including:

a plurality of pontoons articulatingly connected to each other;

a mooring point for mooring the wave-powered energy generation apparatus in a body of water; and

a power generation system which is powered by articulating movement between the pontoons;

wherein at least one of the pontoons is substantially curved.

More specifically, the at least one of the pontoons is generally arcuate-shaped having a convex side and a concave side.

Preferably, the wave-powered energy generation apparatus comprises a centre pontoon which is substantially curved and two substantially cylindrically shaped end pontoons which are each connected to an opposite end of the centre pontoon.

Preferably, the pontoons are connected in series to form an elongate articulated structure having a longitudinal axis, with the mooring point at one end of the articulated structure.

Preferably, adjacent pontoons are connected by a joint.

Preferably, the joint is configured to permit relative rolling movement between adjacent pontoons about a rolling axis which is substantially parallel to the longitudinal axis and relative pitching movement between adjacent pontoons about a pitching axis which is substantially perpendicular to the longitudinal axis.

In one embodiment the joint comprises hinges.

Preferably, the energy generation apparatus includes a propulsion fin to orientate the energy generation apparatus at an angle relative to a mean wave direction.

Preferably, the propulsion fin projects from the concave side of the one of the pontoons.

In one embodiment of the invention one of the pontoons has a ballasting system comprising:

a reservoir having a slosh spout open to an upper side of the pontoon; and

a funnel open to the upper side of the pontoon and in fluid communication with the reservoir.

According to another aspect of the invention there is provided a ballasting system for a pontoon, the ballasting system comprising:

a reservoir having a slosh spout open to an upper side of the pontoon; and

a funnel open to the upper side of the pontoon and in fluid communication with the reservoir.

### BRIEF DESCRIPTION OF THE DRAWINGS

To assist in understanding the invention and to enable a person skilled in the art to put the invention into practical effect, the preferred embodiments of the invention will be described by way of example only with reference to the accompanying drawings, where:

FIG. 1 shows a diagrammatic perspective view of a wave-powered energy generation apparatus in accordance with the invention;

FIG. 2 shows another diagrammatic perspective view of the wave-powered energy generation apparatus of FIG. 1;

FIG. 3 shows a diagrammatic top view of the wave-powered energy generation apparatus of FIG. 1;

FIG. 4 shows a diagrammatic side view of the wave-powered energy generation apparatus of FIG. 1 from one side of the wave-powered energy generation apparatus;

FIG. 5 shows a diagrammatic side view of the wave-powered energy generation apparatus of FIG. 1 from the other side of the wave-powered energy generation apparatus;

FIG. 6 shows a diagrammatic side view of the wave-powered energy generation apparatus of FIG. 1 as it lies in the waves of a body of water;

FIG. 7 shows a diagrammatic side perspective view of the joint between pontoons of the wave-powered energy generation apparatus of FIG. 1;

FIG. 8 shows a diagrammatic top perspective view of the joint of FIG. 7;

FIG. 9 shows a diagrammatic top view showing the layout of the hydraulic powered electricity generation system of the wave-powered energy generation apparatus of FIG. 1;

FIG. 10 shows a diagrammatic plan view of the sequence of the wave-powered energy generation apparatus of FIG. 1 being propelled to a position at an angle relative to the mean wave direction;

FIG. 11 shows a diagrammatic perspective view of another embodiment of a wave-powered energy generation apparatus in accordance with the invention;

FIG. 12 shows a sectional side view of a pontoon including a ballasting system of the wave-powered energy generation apparatus in accordance with the invention;

FIG. 13 shows a top view of the pontoon of FIG. 12;

FIG. 14 shows partially sectioned view of another embodiment of a joint between the pontoons of a wave-powered energy generation apparatus in accordance with the invention;

FIG. 15 shows another partially sectioned perspective view of the joint of FIG. 14; and

FIG. 16 shows yet another partially sectioned perspective view of the joint of FIG. 14.

### DESCRIPTION OF THE PREFERRED EMBODIMENTS

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

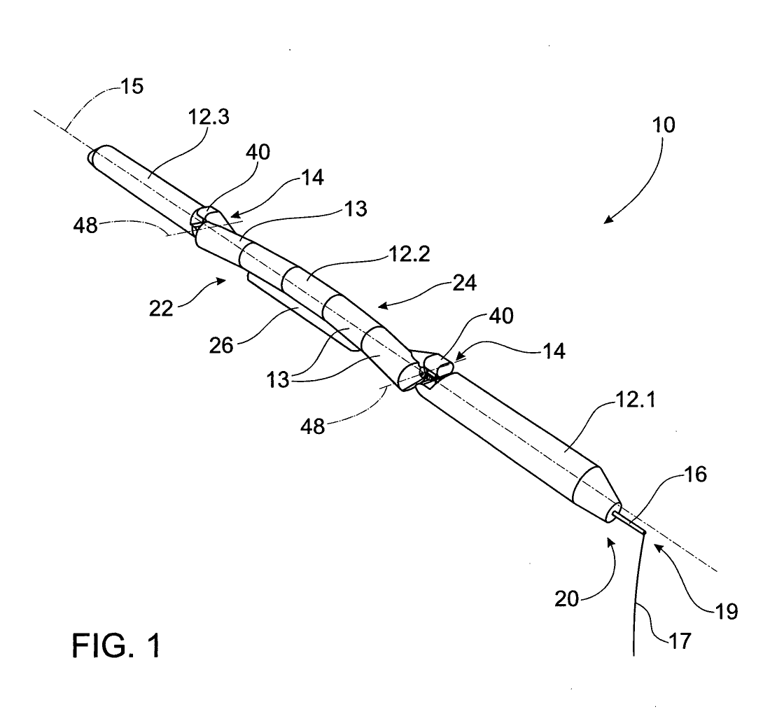

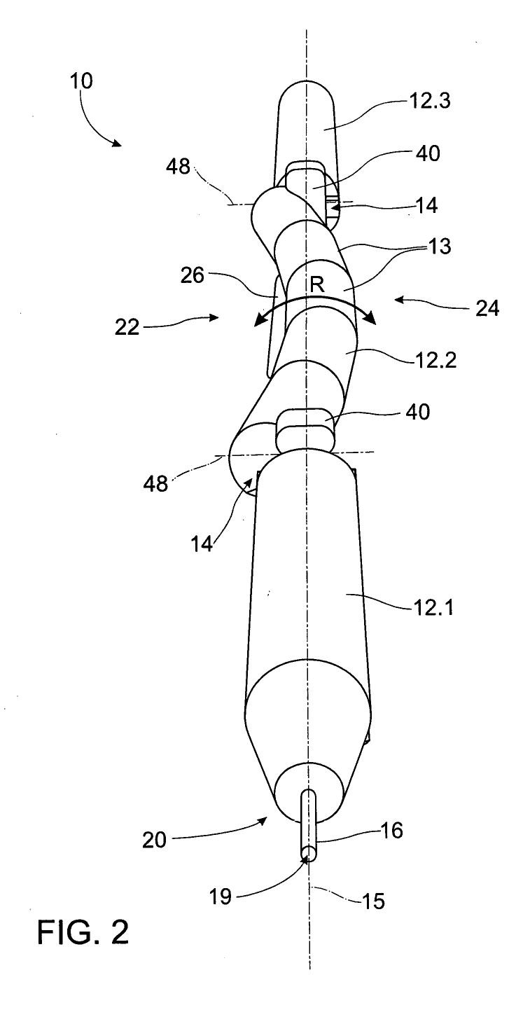

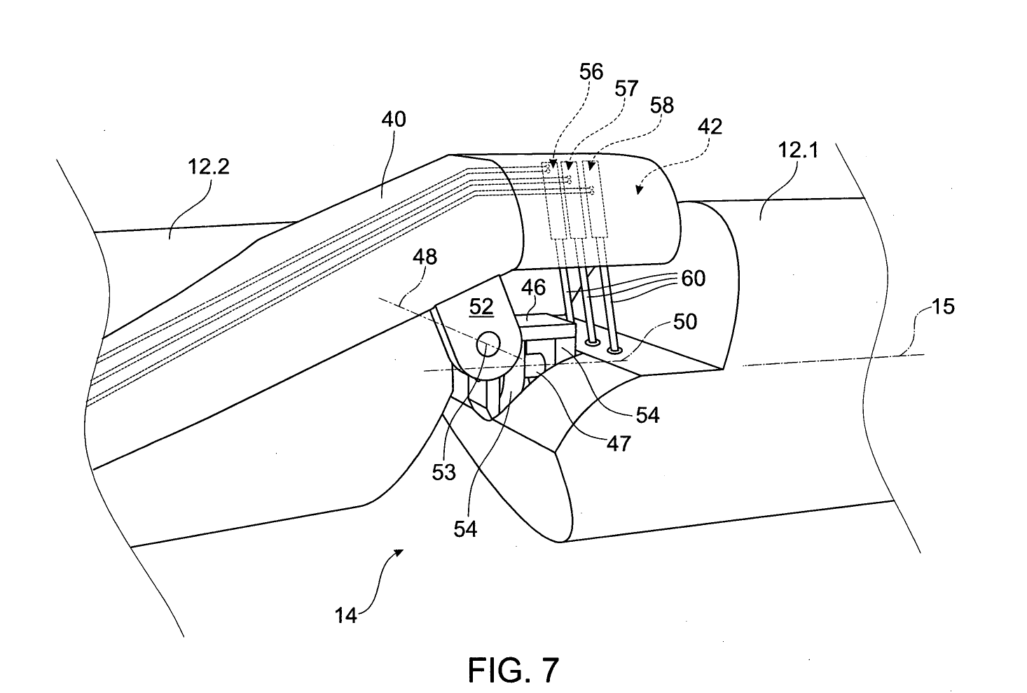

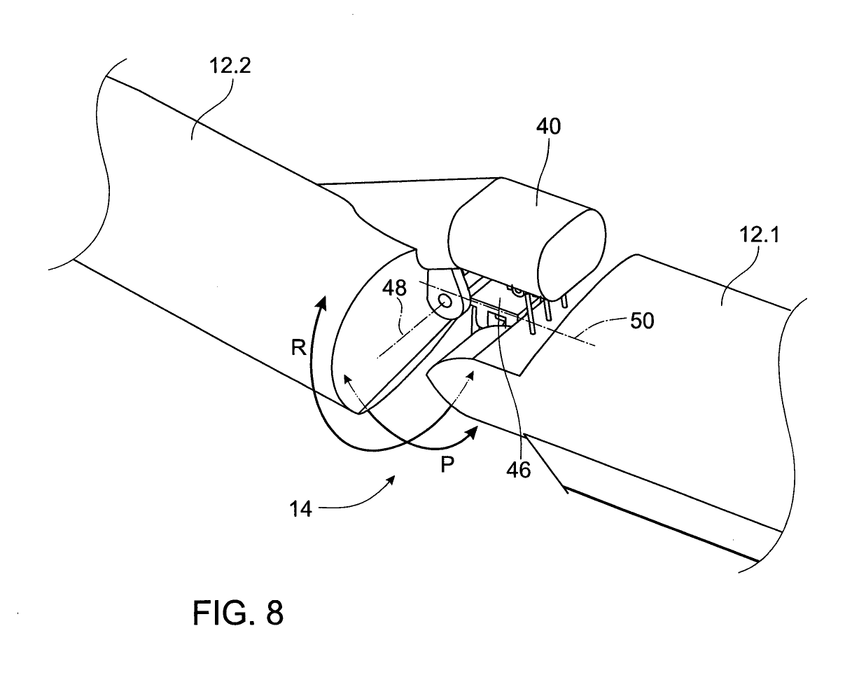

With reference to FIGS. 1 to 6, a wave-powered energy generation apparatus, in accordance with the first form of the invention, is designated generally by reference numeral 10. The apparatus 10 comprises two end pontoons, namely a fore pontoon 12.1 and an aft pontoon 12.3, and a centre pontoon 12.2. The pontoons 12.1, 12.2 and 12.3 are connected to each other end-to-end in series to form an elongate articulated structure. The apparatus 10 has a longitudinal axis 15 of rotation. The pontoons 12 are articulatingly connected to each other by joints 14, which will be discussed in more detail with reference to FIGS. 7 and 8 of the drawings. The joints 14 allow for articulating movement between the respective pontoons 12. The centre pontoon 12.2 has protruding arms 40 at its opposite ends which connect to the joints 14.

The fore pontoon 12.1 has a mooring point 19 at a distal end of a mooring arm 16, for mooring the apparatus 10 in a large body of water such as the ocean. In the drawings, the mooring arm 16 is depicted as a cylindrical arm, but it must be appreciated that it may have any shape or configuration. The apparatus 10 is moored in place in ocean waves by an anchor line 17 and an anchor (not shown) connected to the mooring point 19. The mooring point 19 is at a head end 20 of the apparatus 10.

The centre pontoon 12.2 is substantially curved. More specifically, the centre pontoon is generally arcuate-shaped having a concave side 22 and a convex side 24. The centre pontoon 12.2 comprises a number of cylindrical sections 13 which are configured so that when the cylindrical sections 13 are fixed together, they make up the generally arcuate-shaped pontoon 12.2. The fore pontoon 12.1 and aft pontoon 12.3 are generally straight cylindrical. The pontoons 12 are generally round in cross-section, although the Applicant also envisages that they may also be elliptical in cross section.

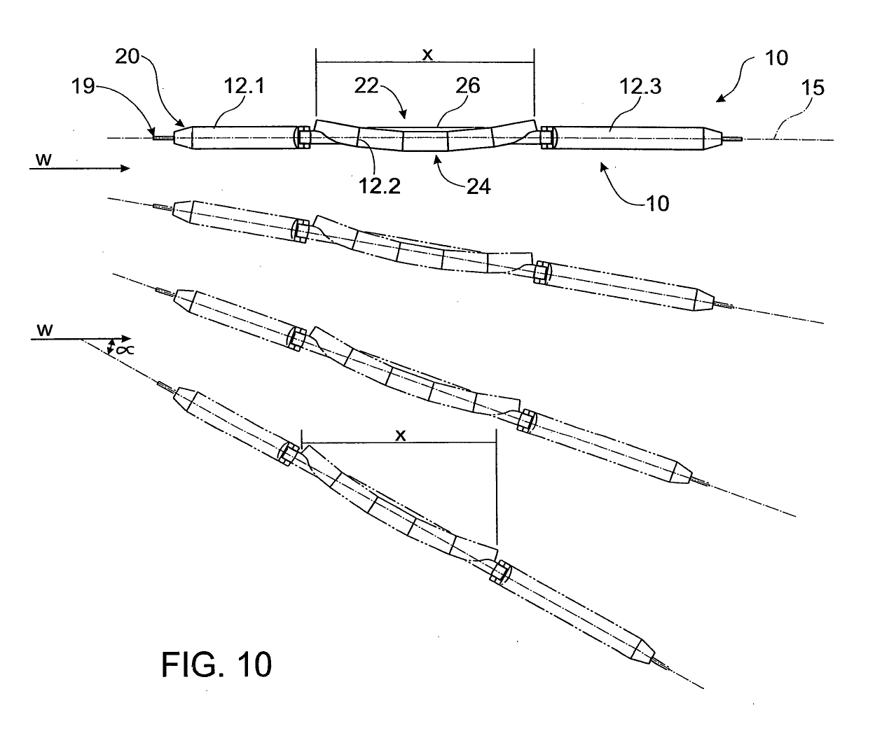

The apparatus 10 further includes a propulsion formation in the form of a propulsion fin 26. The propulsion fin 26 is fixed to the centre pontoon 12.2. The propulsion fin 26 is in the form of a projecting plate. The propulsion fin 26 is positioned intermediate between the opposite ends of the centre pontoon 12.2, on the concave side 22 of the pontoon 12.2. The propulsion fin 26 projects outwardly from the concave side 22 of the pontoon 12.2 and is angled downwardly so that it projects into the ocean. In use, the propulsion fin 26 is below the ocean surface. Rolling of the pontoon 12.2 causes the propulsion fin 26 to move in a finning motion, thereby driving the pontoon 12.2 in a direction bringing the convex side 24 of the pontoon 12.2, face-on with the impinging waves. The functionality of the propulsion fin 26 is described in more detail with reference to FIG. 10 of the drawings.

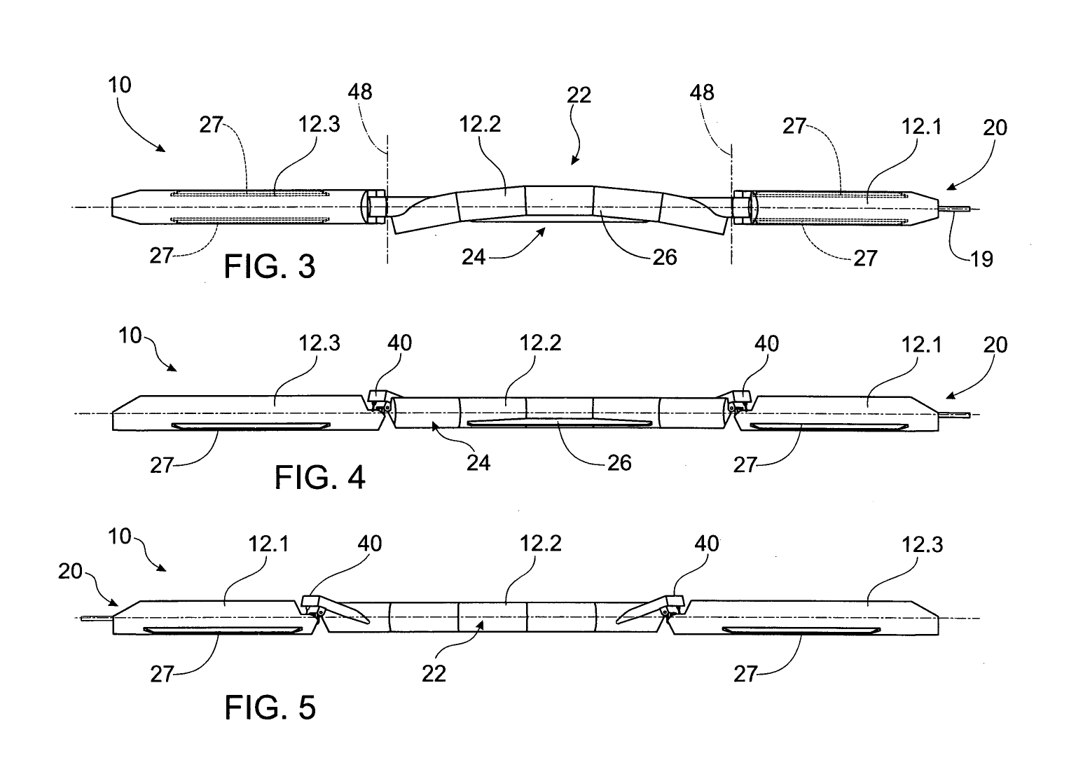

Further referring to FIGS. 3 to 6, the fore pontoon 12.1 and aft pontoon 12.3 have stabilizing fins 27 to stabilize the pontoons 12.1 and 12.3 in rough sea conditions. The stabilizing fins 27 resist rolling motion of the pontoons 12.1 and 12.3 so that there is relatively more torque generated in the rolling movement between the centre pontoon 12.2 and the pontoons 12.1 and 12.3.

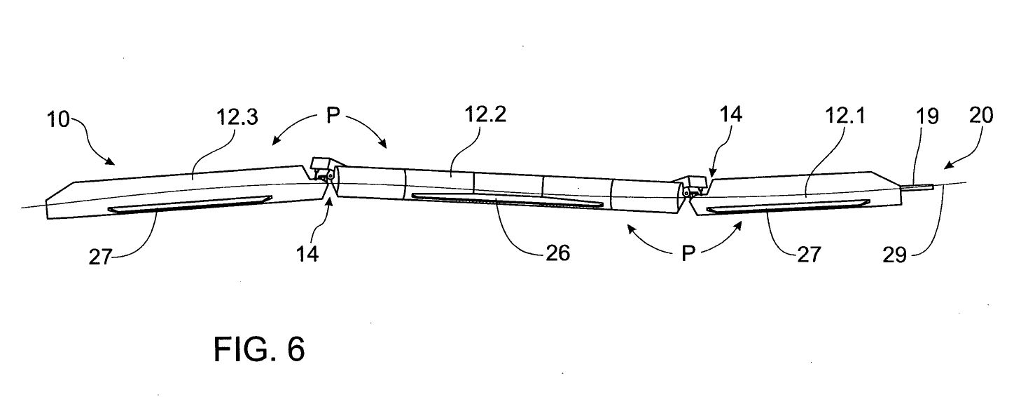

Further referring to FIG. 6, a waveline 29 is shown which represents the surface profile of waves or swells in the ocean. FIG. 6 shows the manner in which the apparatus 10 follows the surface profile of the swells by pitching “P” by articulation at the joints 14.

With reference to FIGS. 7 and 8 of the drawings, each end of the centre pontoon 12.2 has an outwardly projecting arm 40. A housing 42 is located at the distal end of the arm 40. A hinge hub 46 of the joints 14 is captured by the centre pontoon 12.2 at the arm 40 and by the proximate end of the fore pontoon 12.1. Two spaced lugs 52 project downwardly from the arm 40. The hinge hub 46 is captured between opposite eyes of the lugs 52 by a pin 53. The hinge hub 46 is rotatable about a pitching axis 48 which extends between the eyes of the lugs 52. The pontoons 12.1 and 12.3 are thus hinged relative to the centre pontoon 12.2 about the pitching axis 48 at either ends of the centre pontoon 12.2. The pitching axis 48 is perpendicular to the longitudinal axis 15 of the apparatus 10.

The hinge hub has lugs 54 which are captured by a pin 47 fixed at the proximate end of the fore pontoon 12.1. The hinge hub 46 is rotatable about a rolling axis 50 which extends between the eyes of the lugs 54. The pontoons 12 can thus roll relative to each other about the rolling axis 50.

The rolling axis 50 and the pitching axis 48 are perpendicular to each other. The rolling axis 50 is on the longitudinal axis 15 of the apparatus 50. The pitching axis 48 is spaced above the rolling axis 50. The hinge hub 46 does not allow yawing articulation of the pontoons 12 relative to each other.

Three hydraulic pistons 56, 57, 58 are housed in the housing 42. The pistons 56,57,58 have rams 60 which connect to the proximate ends of the fore pontoon 12.1. Pitching motion of the fore pontoon 12.1 relative to the centre pontoon 12.2 about the pitching axis 48 pumps all of the pistons 56, 57 and 58. Relative rolling motion of the fore pontoon 12 about the rolling axis 50 pumps the pistons 56 and 58.

The joint 14 and hydraulic piston configuration have been described with reference to the connection between the centre pontoon 12.2 and the fore pontoon 12.1. The joint 14 and hydraulic piston configuration between the centre pontoon 12.2 and aft pontoon 12.3 is exactly the same.

The Applicant envisages that the stroke of the pistons 56,57,58 may be temporarily constrained to dampen pitching and rolling movement between the pontoons 12. Such a constraint would assist the apparatus 10 to achieve a required angle α as will be described with reference to FIG. 10. For example, constraining the pitching movement in favour of rolling movement would result in the fin 26 applying more sideways force, thereby rotating the apparatus 10 through angle α. Alternatively, constraining the rolling movement would result in the sideways force being reduced and the apparatus 10 returning to an orientation perpendicular to the wave direction. The extent of constraint may be dependant on the sea conditions, i.e. wave height and period.

Further referring to FIG. 8, arrows indicate articulating movement of the pontoons 12 relative to each other. The joints 14 allow rolling movement and pitching movement of the pontoons 12 relative to each other. Rolling movement is indicated by arrows “R” and pitching movement is indicated by arrows “P”. The joints 14 do not allow articulating movement in the yaw direction.

Pitching and rolling of the pontoons 12 relative to one another allow the apparatus 10 to fit to the surface profile of the ocean waves as the waves pass along the length of the apparatus 10. The apparatus 10 is especially effective at maximizing rolling articulation due to the arcuate shape of the centre pontoon 12.2. The arcuate shape of the centre pontoon 12.2 allows the concave side 22 of the centre pontoon 12.2 to fit on the peak of a wave and the convex side 24 to fit in the trough of the wave, effectively rolling the pontoon 12 between the two sides 22, 24 as a wave passes. When seas are rough, dangerously high “slamming” forces can develop at the joints between surface-following articulated wave-powered energy generation apparatus. The apparatus 10 limits the development of such a slamming forces by the rolling action of the central pontoon 12.2 to smooth out relative motion between adjacent pontoons in rough seas.

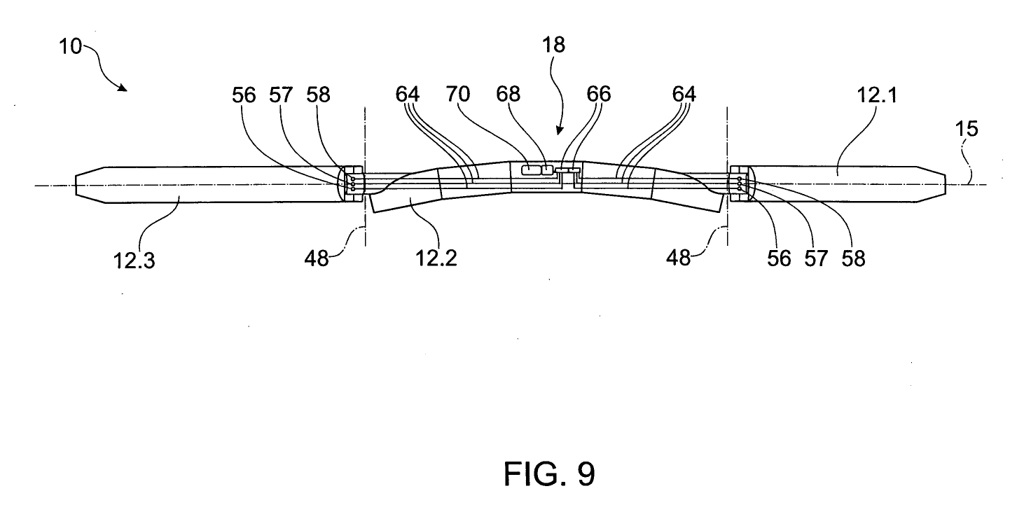

With reference to FIG. 9 of the drawings, the apparatus 10 includes a hydraulic powered electricity power generation system 18. The power generation system 18 comprises the pistons 56, 57, 58, hydraulic lines 64, a hydraulic fluid accumulator 66, a hydraulic motor 68 and an electric power generator 70. The pistons 56, 57, 58 are connected to the hydraulic fluid accumulator via the hydraulic lines 64. The pistons 56, 57, 58 pressurise the hydraulic fluid in the accumulator 66 as they are pumped during articulating movement of the pontoons 12 relative to each other. The accumulator 66 is connected to the hydraulic motor 68. The pressurised hydraulic fluid in the accumulator 66 drives the motor 68. The motor 68 has a driven shaft which drives the electric generator 70, thereby to generate electricity. The accumulator 66, motor 68 and generator 70 are located centrally between the opposite ends of the centre pontoon 12.2. Electricity generated by the electric generator 70 can be tapped by running electric cables from the electricity generator to a point onshore.

With reference to FIG. 10 of the drawings, the manner in which the apparatus 10 is driven into orientation relative to the mean wave direction (W) is shown by successive depictions of the apparatus 10.

As described hereinabove, rolling of the centre pontoon 12.2 drives the propulsion fin 26 up and down in a finning motion. The finning motion of the propulsion fin 26 drives the pontoon 12.2 in a direction from the concave side 22 to the convex side 24. As the pontoon 12.2 is displaced, the whole apparatus 10 pivots about the mooring point 19.

As the propulsion fin 26 pushes the apparatus 10 about its mooring point 19, an angle α is defined between the longitudinal axis of rotation 15 of the apparatus 10 and the mean wave direction W. The angle α will vary depending on the sea conditions and any constraint placed on relative articulation between the pontoons.

One of the benefits of pivoting the apparatus 10 about the mooring point 19 is that as the angle α varies, the effective length of apparatus 10 and thus the effective pontoon lengths X of the pontoons 12 vary accordingly. The effective pontoon length X is the distance between ends of a pontoon 12 measured in the mean wave direction W. The pontoons 12 and apparatus 10 is thus able to be “tuned” to the wavelength by varying the angle α. Altering angle α also has the advantage of avoiding excessive pitching or rolling movements.

Generally, larger angle α is more suitable for shorter wavelengths, where pontoon 12 pitching can be kept resonant with the wave by ideally reducing X to half the sea wavelength. A larger angle α is suitable for longer wavelengths where X is closer to half the seas wavelength.

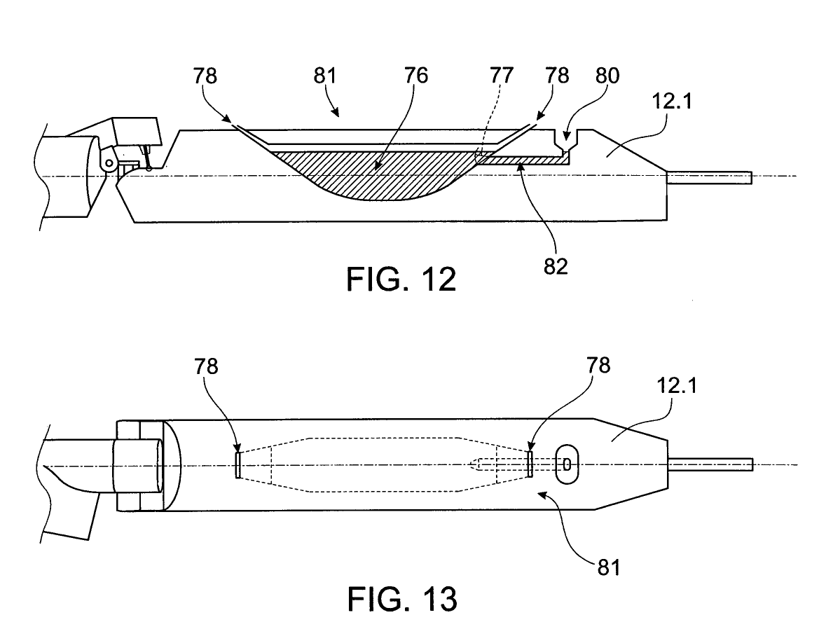

The pontoons 12 are ballasted by either sand or water so that the pontoons are semi-submerged in the ocean. Alternatively, the pontoons 12 may be ballasted by a ballasting system as described with reference to FIGS. 12 and 13.

One of the advantages of apparatus 10 is that the arcuate shape of the pontoons are more effective at surface-following than known cylindrical pontoons and enables the individual pontoons to be longer in length than straight cylindrical pontoons. The combined relative rolling and pitching movement between the pontoons 12 increase the efficiency of electricity generation by the apparatus 10.

A further advantage of the apparatus 10 is that propulsion of the apparatus 10 by the finning motion of the propulsion fin 26 orientates the apparatus 10 at an angle relative to the mean wave direction, enabling the pitching and rolling movement between the pontoons 12, to be tuned to the sea conditions. This increases the efficiency of electricity generation by the apparatus 10. The self-propulsion of the apparatus 10 obviates the need for mooring wires to arrest the structure in the preferred orientation. Appropriate mooring lines will, however, be used to ensure that the apparatus 10 is orientated in at least a general an orientation with the head end 20 pointed in the direction of oncoming waves/swells.

Further, because the propulsion fin 26 of the apparatus 10 is driven by the articulation between the pontoons 12, the apparatus can be said to be self-tuning to the sea conditions by varying the angle α has described with reference to FIG. 10.

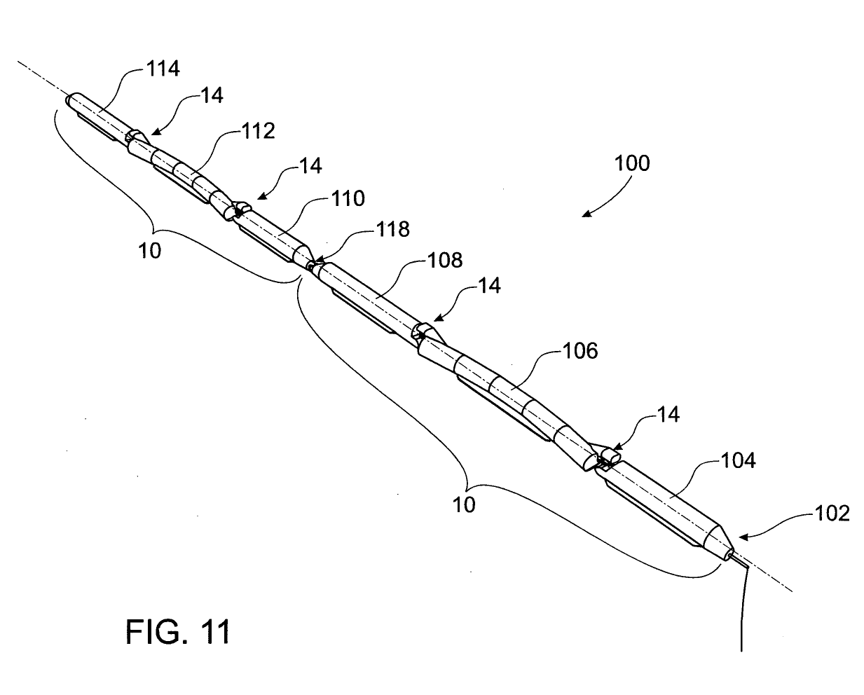

With reference to FIG. 11, another embodiment of a wave-powered energy generation apparatus, in accordance with the invention, is designated generally by reference numeral 100. The apparatus 100 essentially comprises two apparatus 10 connected end to end. The apparatus 100 comprises, from its head end 102, a first fore pontoon 104, a first centre pontoon 106, a first aft pontoon 108, a second fore pontoon 110, a second centre pontoon 112 and a second aft pontoon 114. The first fore pontoon 104 is the same as the fore pontoon 12.1 of the apparatus 10. The second fore pontoon 110 is similar to the first fore pontoon 104, except that the second fore pontoon 110 is linked to the first aft pontoon 108 by a universal joint 118. The centre pontoons 106 and 112 are the same as the centre pontoons 12.2 of the apparatus 10. The aft pontoons 108 and 114 are the same as the aft pontoons 12.3 of the apparatus 10. Features of the apparatus 100 which are the same or similar to features of the apparatus 10 are referenced by the same or similar reference numerals.

Referring to FIGS. 12 and 13, a ballasting system for the fore pontoon 12.1 is shown. The ballasting system comprises a reservoir 76 which has two slosh spouts 78 open to the upper side 81 of the pontoon 12.1. The ballasting system includes a funnel 80 which feeds the reservoir 76 via a duct 82. A flap 77 at the opening between the duct 82 and the reservoir 76 acts as a one-way valve to prevent water in the reservoir from sloshing out through the funnel 80. The funnel 80 is open to the upper side 81 of the pontoon 12.1. The reservoir 76 is filled with water which enters the reservoir 76 via the funnel 80. Water sloshes out of the reservoir 76 through the slosh spouts 78. The slosh spouts 78 have relatively smaller mouth openings than the mouth opening to the funnel 80 so that water does not readily enter the reservoir 76 via the slosh spouts 78. The reservoir 76 has a curved bottom which promotes sloshing of the water in the reservoir 76. In use, the reservoir 76 fills with water during rough sea conditions via the funnel 80. Water from the waves or swell washing over the pontoon 12.1 enters the reservoir 76 through the funnel 80. During calmer conditions the waves or swell do not wash over the pontoon 12.1, but the wave action is sufficient for water in the reservoir 76 to slosh out of the reservoir via the slosh spouts 78. The pontoon 12.1 is thus more ballasted during rough sea conditions and less ballasted during calmer conditions. The ballasting system is also incorporated in the aft pontoon 12.3 and centre pontoon 12.2.

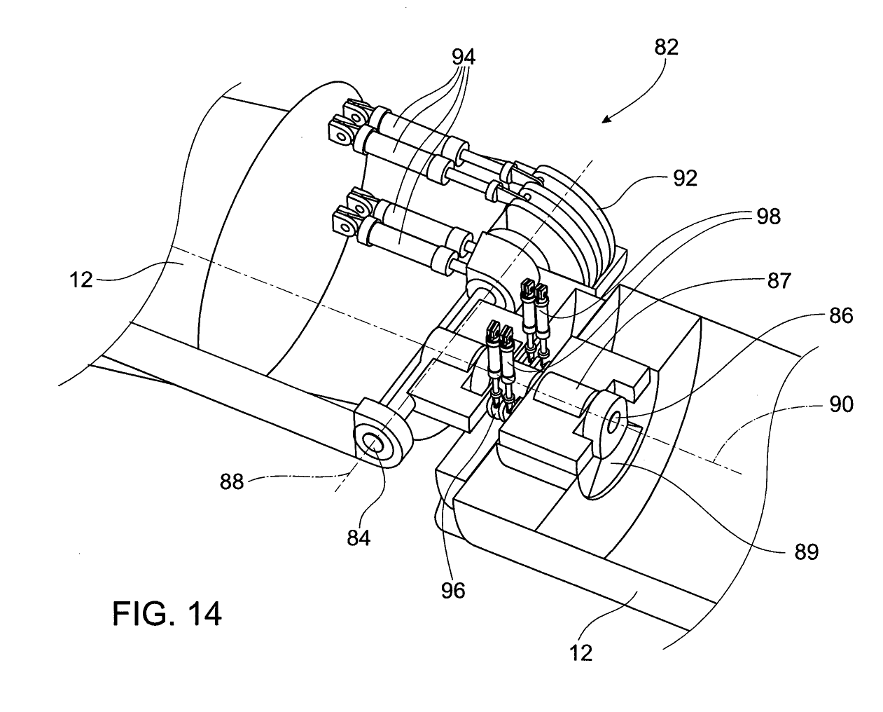

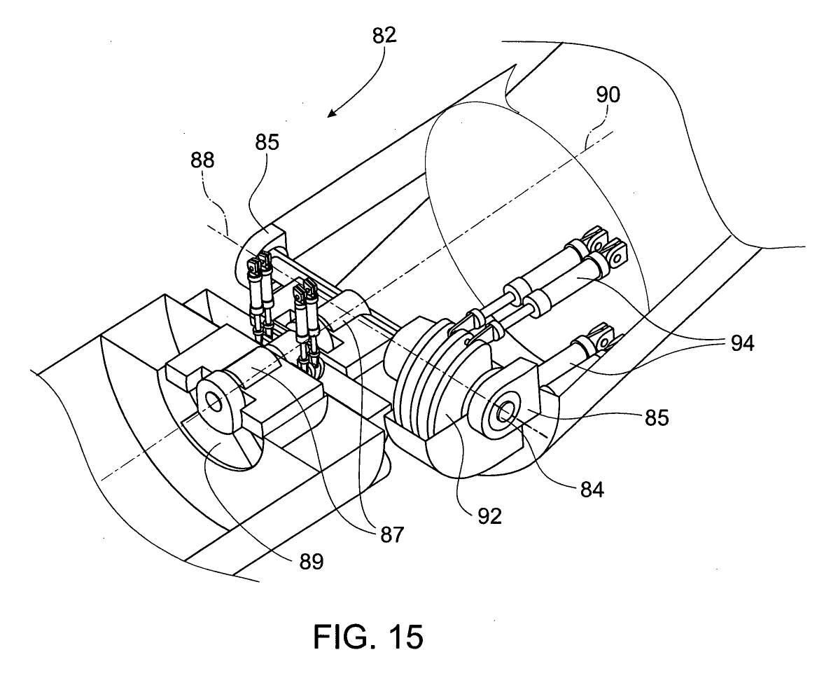

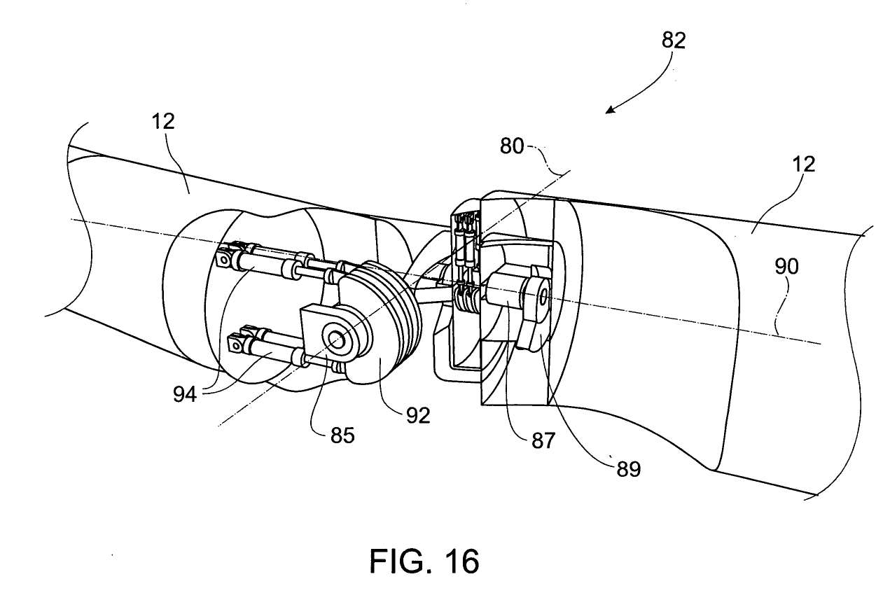

Referring to FIGS. 14 to 16, another embodiment of a joint in accordance with an aspect of the invention is designated by reference numeral 82. The joint 82 comprises a T-shaped axle having two shafts 84, 86 which are square relative to each other. The shaft 84 defines a pitching axis 88 and the shaft 86 a rolling axis 90. The shaft 84 is captured between spaced lugs 85 fixed at the end of one of the pontoons 12. The shaft 86 is captured by collars 87 of an adjacent pontoon 12. A stop formation 89 at the end of the shaft 86 prevents the shaft 86 from being released from the collars 87.

A cam 92 is fixed to the shaft 84. The cam 92 rocks as the pontoons 12 articulate in a pitching motion about the pitching axis 88. Pistons 94 are fixed to the cam 92 at one end and to the centre pontoon 12 at the other end in an arrangement wherein the pistons 94 are pumped as the cam 92 rocks. Similarly, a cam 96 is fixed to the shaft 86. The cam 96 rocks as the pontoons 12 roll relative to each other. Pistons 98 are fixed to the cam 96 at one end and to the pontoon 12 at the other end in an arrangement wherein the pistons 98 are pumped as the cam 96 rocks. The pistons 94 and 98 power the electricity power generation system 18 as described with reference to FIG. 9.

The above description of various embodiments of the present invention is provided for purposes of description to one of ordinary skill in the related art. It is not intended to be exhaustive or to limit the invention to a single disclosed embodiment. For example, a wave-powered energy generation apparatus in accordance with the invention may comprise a number of substantially curved pontoons articulatingly connected to each other. As such, the fore pontoon 12.1 and aft pontoon 12.3 of the apparatus 10 may be similarly shaped as the centre pontoon 12.2. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A wave-powered energy generation apparatus including:
a plurality of pontoons articulatingly connected to each other;
a mooring point for mooring the wave-powered energy generation apparatus in a body of water; and
a power generation system which is powered by articulating movement between the pontoons;
wherein at least one of the pontoons is substantially curved.

2. The wave-powered energy generation apparatus of claim 1, wherein the at least one of the pontoons is generally arcuate-shaped having a convex side and a concave side.

3. The wave-powered energy generation apparatus of claim 1 comprising a centre pontoon which is substantially curved and two substantially cylindrically shaped end pontoons which are each connected to an opposite end of the centre pontoon.

4. The wave-powered energy generation apparatus of claim 1, wherein the pontoons are connected in series to form an elongate articulated structure having a longitudinal axis, with the mooring point at one end of the articulated structure.

5. The wave-powered energy generation apparatus of claim 4, wherein adjacent pontoons are connected by a joint.

6. The wave-powered energy generation apparatus of claim 5, wherein the joint is configured to permit relative rolling movement between adjacent pontoons about a rolling axis which is substantially parallel to the longitudinal axis and relative pitching movement between adjacent pontoons about a pitching axis which is substantially perpendicular to the longitudinal axis.

7. The wave-powered energy generation apparatus of claim 6, wherein the joint comprises hinges.

8. The wave-powered energy generation apparatus of claim 1, wherein the pontoons are generally round in cross-section.

9. The wave-powered energy generation apparatus of claim 2, wherein the energy generation apparatus includes a propulsion fin to orientate the energy generation apparatus at an angle relative to a mean wave direction.

10. The wave-powered energy generation apparatus of claim 9, wherein the propulsion fin projects from the concave side of the at least one of the pontoons.

11. The wave-powered energy generation apparatus of claim 1, wherein at least one of the pontoons has a ballasting system comprising:
a reservoir having a slosh spout open to an upper side of the pontoon; and
a funnel open to the upper side of the pontoon and in fluid communication with the reservoir.

12. A ballasting system for a pontoon, the ballasting system comprising:
a reservoir having a slosh spout open to an upper side of the pontoon; and
a funnel open to the upper side of the pontoon and in fluid communication with the reservoir.
